(19) United States
(12) Patent Application Publication
(10) Pub. No.: US 2014/0030691 A1
(43) Pub. Date: Jan. 30, 2014

(54) System and Method for Collaborative Electronic Textbook Authoring, Instructional Material Generation, Coursework Distribution, and Feedback-Based Content Adaptation

(71) Applicants: Siew Mui Pamela LIU, Singapore (SG); Japher LIM, Singapore (SG)

(72) Inventors: Siew Mui Pamela LIU, Singapore (SG); Japher LIM, Singapore (SG)

(21) Appl. No.: 13/948,554

(22) Filed: Jul. 23, 2013

Related U.S. Application Data
(60) Provisional application No. 61/674,755, filed on Jul. 23, 2012.

(51) Int. Cl. G09B 5/02

(52) U.S. Cl. CPC G09B 5/02
USPC 434/365

(57) ABSTRACT

A computer-based process for managing electronic textbook (e-textbook) content, generation, distribution, and usage includes receiving inputs corresponding to first e-textbook content from at least one e-textbook author by way of an author interface in communication with a content authoring engine; generating a first e-textbook corresponding to the first e-textbook content in accordance with an e-textbook taxonomy; generating instructional materials corresponding to portions of the first e-textbook in accordance with an instructional materials taxonomy; communicating at least one of first e-textbook content and instructional materials to at least one e-learning application; and receiving feedback by way of a feedback engine, wherein the feedback corresponds to at least one of (a) how instructional materials are utilized by at least one instructor, (b) how instructional materials or first e-textbook content are utilized by students, and (c) a recommendation for revising first e-textbook content in a subsequent edition of the first e-textbook.

The current application claims a priority to the U.S. Provisional Patent application Ser. No. 61/674,755 filed on Jul. 23, 2012.

### TECHNICAL FIELD

The present disclosure relates generally to electronic textbook (e-textbook) generation and use. More particularly, the present disclosure is directed to a system and method for automatically or semi-automatically generating e-textbook content and associated instructional material; distributing coursework; and providing feedback from instructors and/or students to e-textbook content authors to facilitate collaborative e-textbook content changes or revisions.

### BACKGROUND

Electronic textbooks (e-textbooks) offer the promise of very wide distribution of educational materials at moderate or low cost, to facilitate structured or self-paced electronic-based learning. Unfortunately, the generation, management, or control of e-textbook content by e-textbook authors using current e-textbook authoring systems can be cumbersome. Additionally, the generation, management, or controlled distribution of instructional materials corresponding to e-textbooks can be cumbersome. Furthermore, e-textbook authors typically have an undesirably limited idea of which portions of an e-textbook are most relevant or most useful (or correspondingly, least relevant/least useful) to instructors and/or students, and hence subsequent editions of an e-textbook may not adequately focus on or include sufficient material that is especially relevant or useful. A need exists for e-textbook management systems and processes that can overcome such shortcomings.

### SUMMARY

Embodiments in accordance with the present disclosure overcome the shortcomings or disadvantages of prior e-textbook content management systems and processes by way of an automated networked or networkable system by which (a) authors can easily define, manage, and edit e-textbook content in accordance with an e-textbook taxonomy; (b) instructional materials can be automatically or semi-automatically generated, and instructors can easily define, manage, edit, and administer instructional materials in accordance with an instructional materials taxonomy; (c) e-textbook content and/or instructional materials can be automatically communicated to one or more types of student study course devices that students may access or use at any given time; and (d) feedback, corresponding to e-textbook content, e-textbook content usage, instructional materials content, and/or instructional materials usage can be communicated to instructors and/or e-textbook authors. Such feedback can include statistical data that is automatically generated by monitoring/analysis program instructions (e.g., software) executing on one or more instructor study course devices and/or one or more student study course devices, which tracks, monitors, or analyzes one or more respective manners in which instructors and/or students access or utilize particular types of e-textbook and/or instructional materials content. The feedback can provide guidance to e-textbook authors, such as when one or more authors are revising a given edition of an e-textbook and generating a subsequent edition of the e-textbook.

In accordance with an aspect of the present disclosure, an automated process for managing e-textbook content generation, distribution, and usage by way of a computer network includes receiving inputs corresponding to first e-textbook content from at least one e-textbook author by way of an author interface in communication with a content authoring engine; automatically associating the first e-textbook content with an e-textbook taxonomy; automatically generating a first e-textbook corresponding to the first e-textbook content in accordance with the e-textbook taxonomy; and automatically generating instructional materials corresponding to portions of the first e-textbook in accordance with an instructional materials taxonomy.

The e-textbook taxonomy includes or defines hierarchical classifications corresponding to at least some of an e-textbook summary, a unit summary, a chapter summary, chapter details, and author questions. The instructional materials taxonomy is one of a default instructional materials taxonomy and an instructor specified instructional materials taxonomy corresponding to instructor inputs received by way of an instructional material management engine. The instructional materials taxonomy includes or defines hierarchical classifications corresponding to at least some of instructor information, course information, a course plan, lecture materials, a publishing plan, and instructor questions.

The process can further include communicating at least one of first e-textbook content and instructional materials to at least one e-learning application, such as by way of selectively communicating at least one of first e-textbook content and instructional materials corresponding thereto to a set of student study course devices in accordance with a publishing plan that forms a portion of the instructional materials taxonomy.

The process can further include receiving feedback corresponding to at least one of the first e-textbook and the instructional materials corresponding thereto by way of a feedback engine; and providing feedback to at least one of at least one author of the first e-textbook and at least one instructor, wherein the feedback corresponds to at least one of (a) how instructional materials are utilized by at least one instructor, (b) how instructional materials or first e-textbook content are utilized by students, and (c) a recommendation for revising first e-textbook content in a subsequent edition of the first e-textbook.

With respect to such feedback, the process can include automatically monitoring at least one of instructor usage of first e-textbook content, student usage of first e-textbook content, and student usage of instructional materials; and automatically generating statistics corresponding to the automatically monitored at least one of instructor usage of first e-textbook content, student usage of first e-textbook content, and student usage of instructional materials.

In accordance with a further aspect of the present disclosure, the process can include receiving inputs corresponding to second e-textbook content from at least one e-textbook author by way of the author interface; automatically associating the second e-textbook content with the e-textbook taxonomy; automatically generating a second e-textbook corresponding to the second e-textbook content in accordance with the e-textbook taxonomy; and automatically generating instructional materials corresponding to portions of the first e-textbook and portions of the second e-textbook in accordance with the instructional materials taxonomy.

In accordance with another aspect of the present disclosure, an automated process for managing electronic textbook (e-textbook) content generation, distribution, and usage by way of a computer network includes receiving inputs corresponding to first e-textbook content from at least one e-textbook author by way of an author interface in communication with a content authoring engine; automatically associating the first e-textbook content with an e-textbook taxonomy; automatically generating a first e-textbook corresponding to the first e-textbook content in accordance with the e-textbook taxonomy; communicating portions of the first e-textbook to at least one of an instructor study course device and a student study course device; automatically monitoring at least one of (a) instructor access to or usage of first e-textbook content, (b) student access to or usage of first e-textbook content, and (c) access to or usage of instructional materials corresponding to first e-textbook content; and automatically generating statistics corresponding to the automatically monitored at least one of instructor access to or usage of first e-textbook content, student access to or usage of first e-textbook content, and student access to or usage of the instructional materials corresponding to first e-textbook content.

In accordance with an aspect of the present disclosure, an automated system for managing electronic textbook (e-textbook) content generation, distribution, and usage by way of a computer network includes an e-textbook management system having a processing unit, a memory coupled to the processing unit, and a set of engines stored in the memory and executable by the processing unit, the set of engines including: a content authoring engine communicable with the computer network and configured for receiving inputs from least one author interface system to control contents of a first e-textbook and configured for automatically generating the first e-textbook in accordance with an e-textbook taxonomy; and an instructional materials management engine communicable with the computer network and configured receiving instructor inputs from an instructor study course device, the instructor inputs selectively identifying instructional materials content corresponding to portions of the first e-textbook, the instructional materials management engine further configured for automatically generating instructional materials in accordance with an instructional materials taxonomy. The e-textbook management system further includes a coursework management engine communicable with the computer network and configured for communicating at least one of first e-textbook content and instructional materials corresponding thereto to at least one student study course device. The coursework management engine is configured for communicating at least one of first e-textbook content and instructional materials corresponding thereto in accordance with a publishing schedule that forms a portion of the instructional materials taxonomy.

The e-textbook management system can further include a feedback management engine communicable with the computer network and configured for receiving feedback from at least one of an instructor study course device and at least one student study course device, wherein the feedback corresponds to at least one of (a) how instructional materials are utilized by an instructor corresponding to the instructor study course device, (b) how instructional materials or first e-textbook content are utilized by a student corresponding to a student study course device, and (c) an instructor or a student recommendation for revising first e-textbook content in a subsequent edition of the first e-textbook.

An instructor study course device can include one of a desktop computing device, a laptop computing device, a tablet computing device, and a mobile telephone. In accordance with a further aspect of the present disclosure, the instructor study course device includes a processing unit, a memory, and instructor-side course monitoring/analysis program instructions that reside within the memory and which are executable by the processing unit, the instructor-side course monitoring/analysis program instructions configured for monitoring or analyzing instructor use or presentation of first e-textbook content or instructional materials corresponding thereto. For instance, the instructor-side course monitoring/analysis program instructions can be configured for tracking at least one of whether, when, and how often an instructor study course device accesses particular first e-textbook content or instructional material corresponding thereto, and how much time is spent presenting first e-textbook content or instructional material thereto. The instructor-side course monitoring/analysis program instructions can be a built-in or packaged-in portion of the instructor study course device; or downloadable or retrievable software.

A student study course device can include one of a desktop computing device, a laptop computing device, a tablet computing device, a mobile telephone, and a set top box. In accordance with a further aspect of the present disclosure, a student study course device includes a processing unit, a memory, and student-side course monitoring/analysis program instructions that reside within the memory and which are executable by the processing unit, the student-side course monitoring/analysis program instructions configured for monitoring or analyzing student access to and use of first e-textbook content and instructional materials corresponding thereto. For instance, the student-side course monitoring/analysis program instructions can be configured for tracking at least one of (a) what first e-textbook content or instructional material corresponding thereto a student accesses, highlights, or annotates, (b) an amount of time student accessed first e-textbook content or instructional material corresponding thereto is displayed, (c) whether student accessed first e-textbook content or instructional material corresponding thereto is accessed during a study group session involving information sharing between multiple student study course devices, and (d) whether first e-textbook content or instructional material corresponding thereto is accessed during a student quiz. The student-side course monitoring/analysis program instructions can be a built-in or packaged-in portion of the student study course device; or downloadable or retrievable software.

In accordance with a further aspect of the present disclosure, the content authoring engine is configured for receiving inputs from a plurality of author interface systems to control contents of a plurality of distinct e-textbooks, and configured for generating a plurality of distinct e-textbooks in accordance with the e-textbook taxonomy. The instructional materials management engine is configured receiving instructor inputs from a plurality of instructor study course devices, where the instructor inputs received from any given instructor study course device selectively identify instructional materials corresponding to portions of at least one e-textbook (e.g., a first e-textbook, a second e-textbook, and/or another e-textbook, etc. . . . ). The instructional materials management engine is further configured for automatically generating instructional materials corresponding to the at least one e-textbook in accordance with the instructional materials taxonomy.

In accordance with another aspect of the present disclosure, an automated system for managing electronic textbook (e-textbook) content generation, distribution, and usage by way of a computer network includes an e-textbook management system communicable with the computer network, the e-textbook management system having a processing unit, a memory coupled to the processing unit, and a set of engines stored in the memory and executable by the processing unit, the set of engines comprising a content authoring engine communicable with the computer network and configured for receiving inputs from least one author interface system to manage contents of a first e-textbook and configured for automatically generating the first e-textbook in accordance with an e-textbook taxonomy; and at least one of (a) an instructor study course device communicable with the computer network, the instructor study course device comprising a processing unit, a memory, and instructor-side course monitoring/analysis program instructions that reside within the instructor study course device memory and which are executable by the instructor study course device processing unit, the instructor-side course monitoring/analysis program instructions configured for monitoring or analyzing instructor use or presentation of first e-textbook content or instructional materials corresponding thereto; and (b) a set of student study course devices communicable with the computer network, each student study course device comprising a processing unit, a memory, and student-side course monitoring/analysis program instructions that reside within the student study course device memory and which are executable by the student study course device processing unit, the student-side course monitoring/analysis program instructions configured for monitoring or analyzing student access to and use of first e-textbook content or instructional materials corresponding thereto.

The set of engines further includes a feedback management engine configured for communicating with at least one of the instructor study course device and the set of student study course devices to receive feedback corresponding to at least one of (a) instructor use or presentation of first e-textbook content or instructional materials corresponding thereto, and (b) student access to or use of first e-textbook content or instructional materials corresponding thereto.

### BRIEF DESCRIPTION OF THE DRAWINGS

FIG. 1 is a schematic illustration of a system for collaborative e-textbook authoring; instructional material generation; coursework selection/identification/provision/distribution/acquisition/presentation; and/or feedback-based content adaptation in accordance with an embodiment of the present disclosure.

FIG. 2 is a block diagram showing portions of a representative e-textbook management system in accordance with an embodiment of the present disclosure.

FIGS. 3A-3E are schematic illustrations of representative author graphical user interfaces (GUIs) in accordance with an embodiment of the present disclosure.

FIGS. 4A-4I are schematic illustrations showing representative coursework management GUIs in accordance with an embodiment of the present disclosure.

### DETAILED DESCRIPTION

In the present disclosure, the depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated. The use of “configured to” and “configured for” herein are understood to encompass or mean “configurable to,” “configured to,” “configurable for,” and/or “configured for.” Finally, recitation of a particular numerical value or value range herein is understood to be nonlimiting, and can include or be a recitation of a representative or approximate numerical value or value range.

As used herein, the term “set” corresponds to or is defined as a non-empty finite organization of elements that mathematically exhibits a cardinality of at least 1 (i.e., a set as defined herein can correspond to a unit, singlet, or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). In general, an element of a set can include or be a system, an apparatus, a device, a structure, an object, a process, a physical parameter, or a value depending upon the type of set under consideration.

Particular representative embodiments in accordance with the present disclosure are provided herein for purpose of illustration to aid understanding. While such representative embodiments are indicated as having particular structural and/or functional organizations, other embodiments in accordance with the present disclosure can exhibit different structural and/or functional organizations. Moreover, while representative embodiments provided herein are indicated as including particular distinct structural and/or functional elements, certain structural and/or functional elements can be combined or separated/segregated in other embodiments in accordance with the present disclosure.

In accordance with embodiments of the present disclosure, an electronic textbook (e-textbook) includes one or more types of information content (e-textbook content) that can be represented, encoded, or stored in machine readable, machine presentable, computer readable, computer presentable, or electromagnetic (e.g., electronic) form, where such content is intended by at least one e-textbook author, creator, or content contributor to be useful or relevant with respect to a student's learning, mastery, or retention of concepts or subject matter to which the e-textbook content is directed. An e-textbook can be a computer based or electronic analogue or counterpart to a paper-based textbook, and can include essentially any type of information content, collaterals, or media (e.g., text, images, videos, audio, data, case studies, quizzes, or other content) that can be electromagnetically communicated, provided, or presented to instructors and/or students. One or more portions of such content can be organized or structured in accordance with an e-textbook taxonomy or hierarchical schema, as further detailed below.

Embodiments in accordance with the present disclosure are configured for enabling a set of authors to selectively structure, create, and/or revise e-textbook content (a) independently; (b) in collaboration with each other; and (c) in collaboration with one or more instructors and/or students. Collaboration between a set of e-textbook authors and one or more instructors/students can include the communication or provision of one or more types of feedback associated with the instructor(s)/student(s) to the author(s). Such feedback can include comments, ratings, or reviews relating to e-textbook content, organization, or teaching effectiveness; content revision recommendations; or proposed new content suggestions or submissions. Such feedback can additionally or alternatively include e-textbook content usage data or statistics corresponding to or resulting from actual instructor and/or student content access, content interaction, and/or interaction with each other. Content usage or statistics can be automatically generated on an ongoing or periodic basis by way of content usage monitoring software, as further described below.

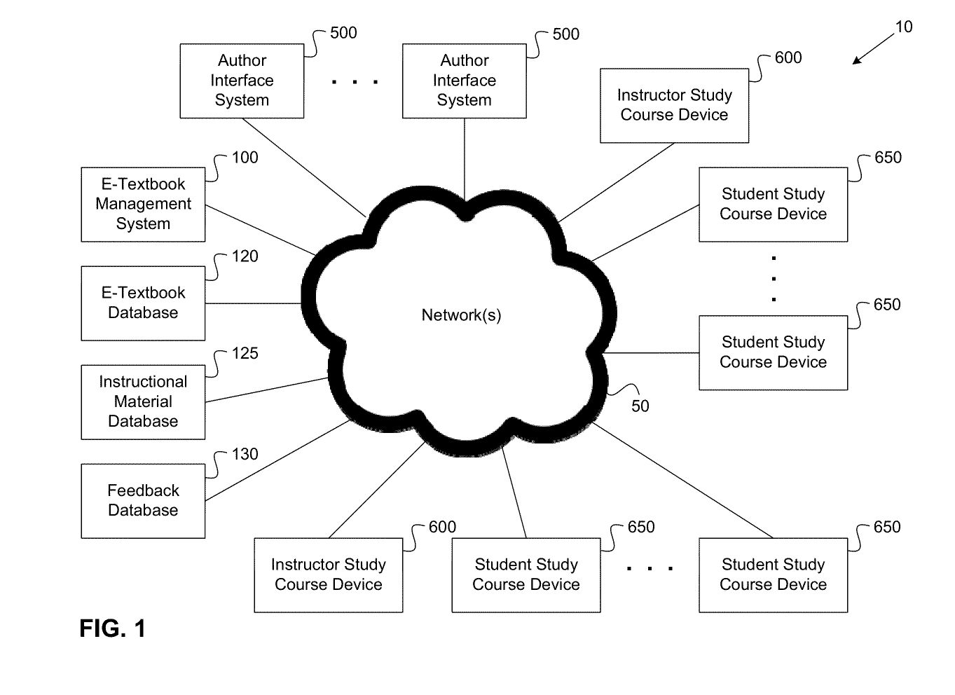

FIG. 1 is a schematic illustration of a system 10 for automatically or semi-automatically facilitating or enabling one or more types of collaborative e-textbook activities or operations, including at least some of the following: e-textbook authoring; instructional material generation; coursework selection/identification/provision/distribution/acquisition/presentation; and feedback-based content adaptation. In an embodiment, the system 10 includes at least one e-textbook management system 100; one or more author interface systems 500; and a set of study course devices or study course management devices 600, 650 associated with one or more instructors and/or students, for instance, a number of instructor study course devices 600 and/or a number of student study course devices 650. The system 10 further includes or is configured for communication with one or more e-textbook content databases 120 in which e-textbook content can reside; one or more instructional material databases 125 in which instructional material content can reside; and one or more feedback databases 130 in which e-textbook related feedback can reside. The e-textbook management system(s) 100, the e-textbook content database(s) 120, the instructional material database(s) 125, the feedback database(s) 130, the author interface system(s) 500, and the study course devices 600, 650 can be configured for network communication by way of one or more networks 50 (e.g., local area, wide area, and/or global wire-based and/or wireless networks, which can include the Internet).

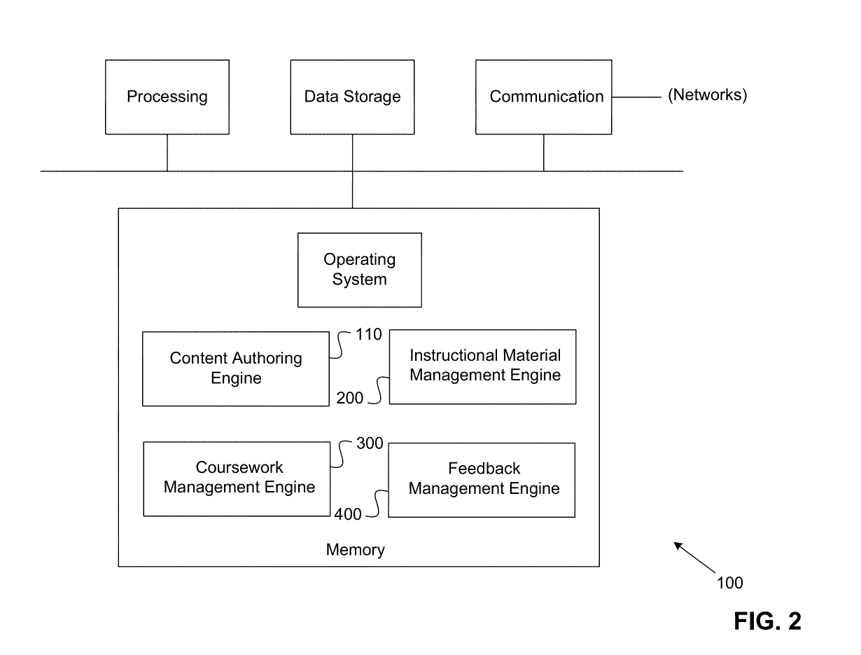

FIG. 2 is a block diagram showing portions of a representative e-textbook management system 100 in accordance with an embodiment of the present disclosure. In an embodiment, an e-textbook management system 100 includes a set of computing systems/devices and/or electronic systems/devices having processing, memory, operating system, data storage, and communication resources. The e-textbook management system 100 includes or is configured for communication with one or more e-textbook content databases 120, instructional material content databases 125, and feedback databases 130. A representative e-textbook management system 100 can correspond to or include a number of servers or cloud computing systems coupled to the Internet.

An e-textbook management system 100 can include program instruction resources (e.g., software) that when executed facilitate or enable particular types of e-textbook related operations, procedures, or processes in accordance with an embodiment of the present disclosure. In an embodiment, an e-textbook management system 100 includes a content authoring engine 110; an instructional material management engine 200; a coursework management engine 300; and a feedback management engine 400, each of which can include or be program instructions that can be stored upon or within one or more machine readable, computer readable, or electronically readable media (e.g., a set of fixed or removable media such as a memory and/or an information storage disk).

The content authoring engine 110 is configured for enabling one or more e-textbook authors to structure, generate, retrieve, and store e-textbook content. Such content is structured and generated in accordance with at least one e-textbook taxonomy or hierarchical content organization schema, which can be predefined, author defined, or author customizable. The instructional material management engine 200 is configured for automatically generating instructional materials from e-textbook content. Such instructional materials can correspond to an e-learning application, presentation slides, quizzes, case studies, and/or other materials (e.g., images or videos). The coursework management engine 300 is configured for managing the communication of e-textbook content and/or associated instructional materials to instructors and/or students. Finally, the feedback management engine 400 is configured for (a) communicating instructor and/or student feedback to one or more e-textbook authors, and (b) managing the generation of e-textbook content revisions based upon such feedback.

An author interface system 500 includes hardware and/or software based interfaces, resources, and tools configured for facilitating or enabling author interaction with the e-textbook management system 100, by which an e-textbook author, creator, or content contributor can (a) organize, generate, identify, designate, retrieve, modify, and/or upload e-textbook content; and (b) access, manage, or respond to e-textbook related feedback. In a representative embodiment, an author interface system 500 can include a desktop, laptop, or tablet computer or computing device configured for providing, presenting, or executing e-textbook content generation/management software tools.

In a number of embodiments, an author interface system 500 and/or the e-textbook management system's content authoring engine 110 are configured for providing a number of graphical user interfaces (GUIs) to e-textbook authors, creators, or contributors. Such GUIs can facilitate or enable the automatic or semi-automatic, selective, and/or adaptive generation, definition, modification, and distribution of first edition and subsequent edition e-textbook content as well as instructional material content in accordance with a taxonomy, hierarchical classification, or categorical organization schema. The taxonomy can correspond to or define hierarchical associations between (a) numerical identifiers, tags, codes, or reference labels, (b) categorical types of e-textbook/instructional material content, and (c) e-textbook/instructional material content itself. Numerical identifiers, tags, codes, or reference labels within the taxonomy can be automatically and adaptively generated or revised/updated as particular categorical types of e-textbook and/or instructional material content are created, inserted, reorganized, or deleted, for instance, in response to author or instructor interaction with a GUI. The numerical identifiers, tags, codes, or reference labels can be linked to content category labels or descriptors, which can be predefined. E-textbook/instructional material content can be flexibly provided, generated, inserted, or referenced by one or more authors or instructors with respect to a hierarchical level or position within the taxonomy. Such a taxonomy is scalable, flexible, and/or adaptable, and can be standardizable/standardized.

In an embodiment, a representative e-textbook taxonomy can include hierarchical classifications corresponding to a book summary, a unit summary, a chapter summary, chapter details, and author questions. A representative instructional material taxonomy can include hierarchical classifications corresponding to instructor information, course information, a course plan, lecture materials, a publishing or publication plan, and instructor questions. E-textbook content and associated instructional material content that is structured relative to a taxonomy in accordance with an embodiment of the present disclosure can be automatically accessed, referenced, read, or utilized by one or more portions of a system or device in accordance with an embodiment of the present disclosure (e.g., by way of system or device use of or reference to one or more taxonomic codes). Furthermore, such taxonomically structured e-textbook content and associated instructional material content can be automatically accessed by an e-learning application or engine (e.g., which facilitates self-paced learning). Particular aspects of representative GUIs that facilitate or enable e-textbook and/or instructional material content generation, editing, and publishing in accordance with such a taxonomy are described in detail hereafter.

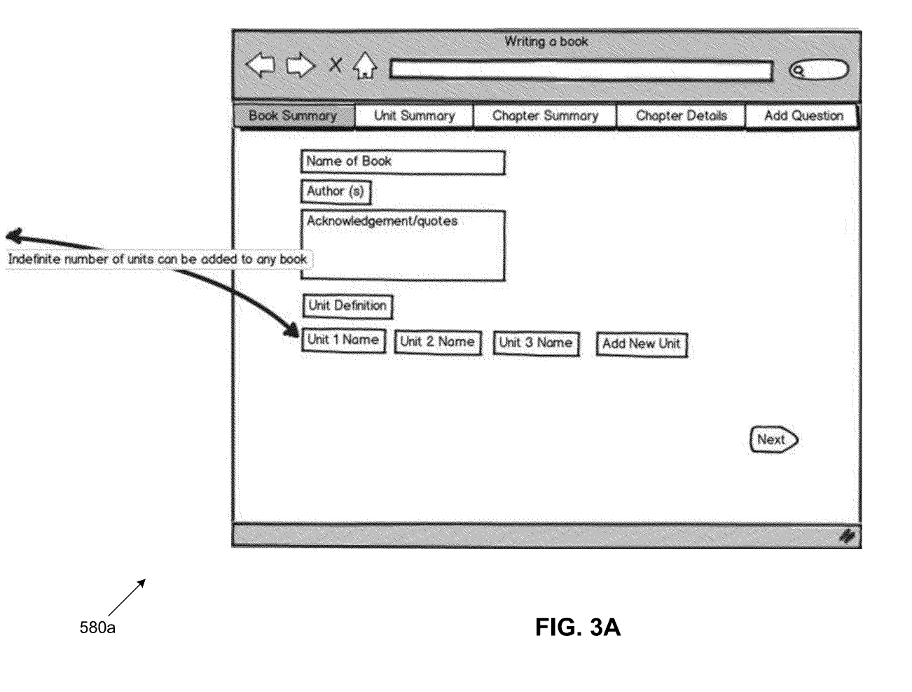

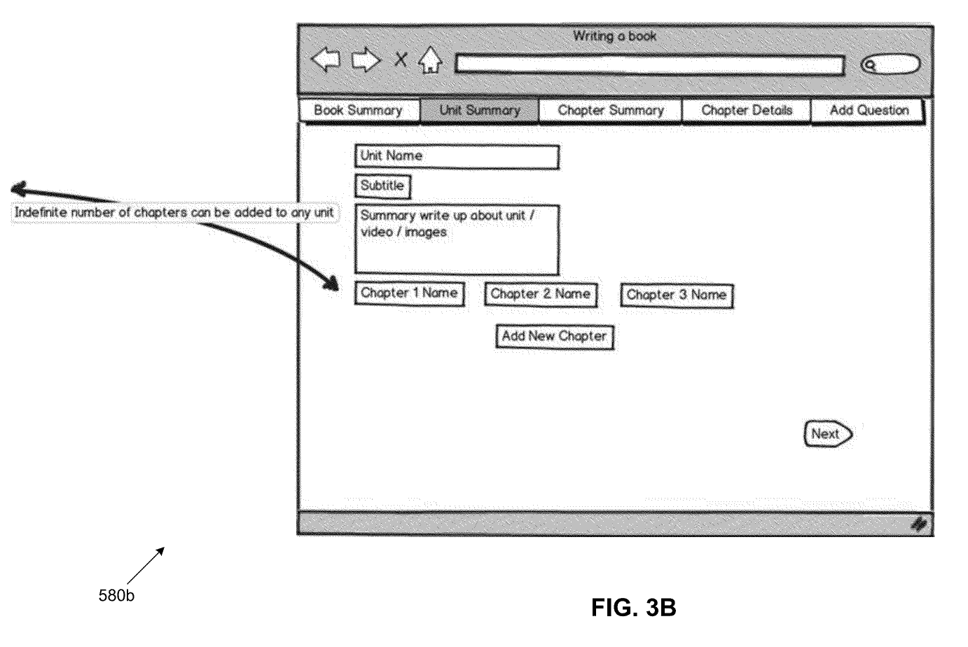

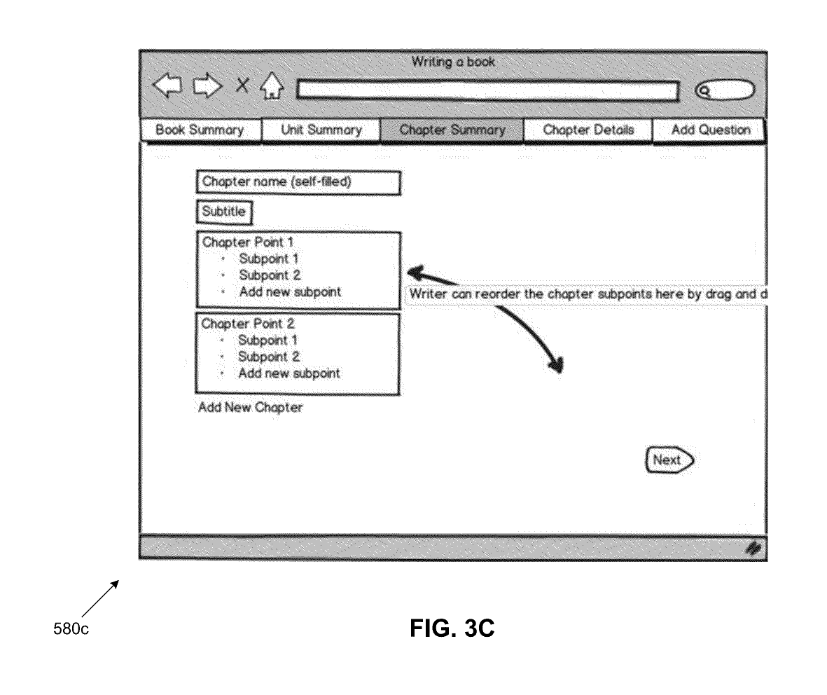

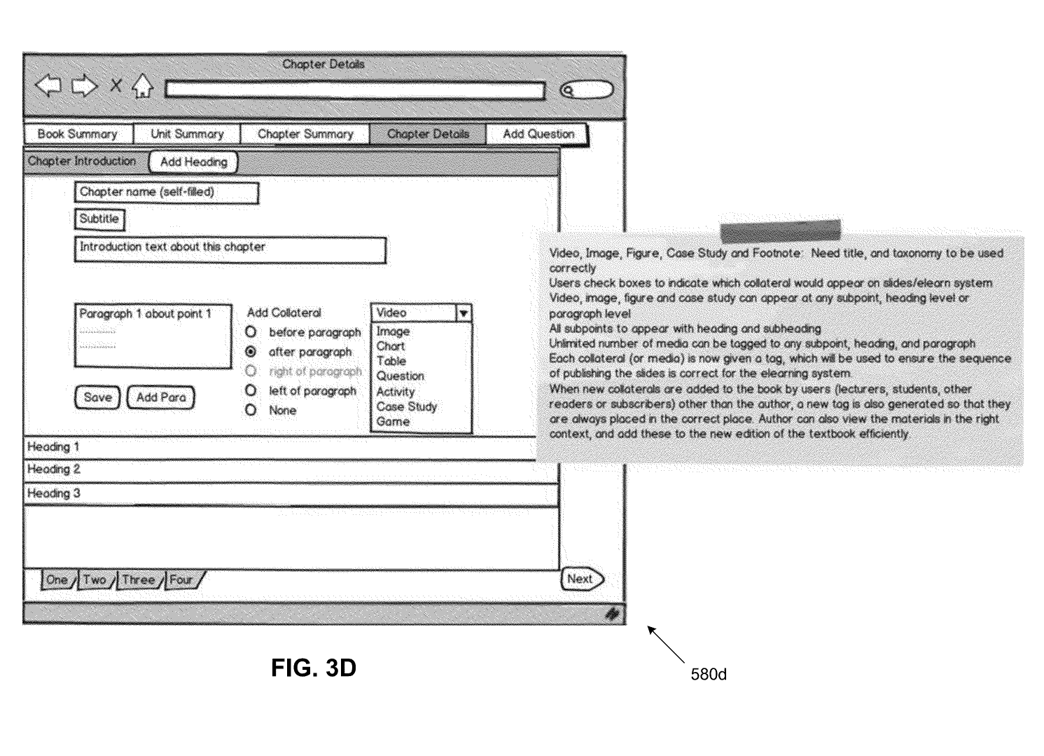

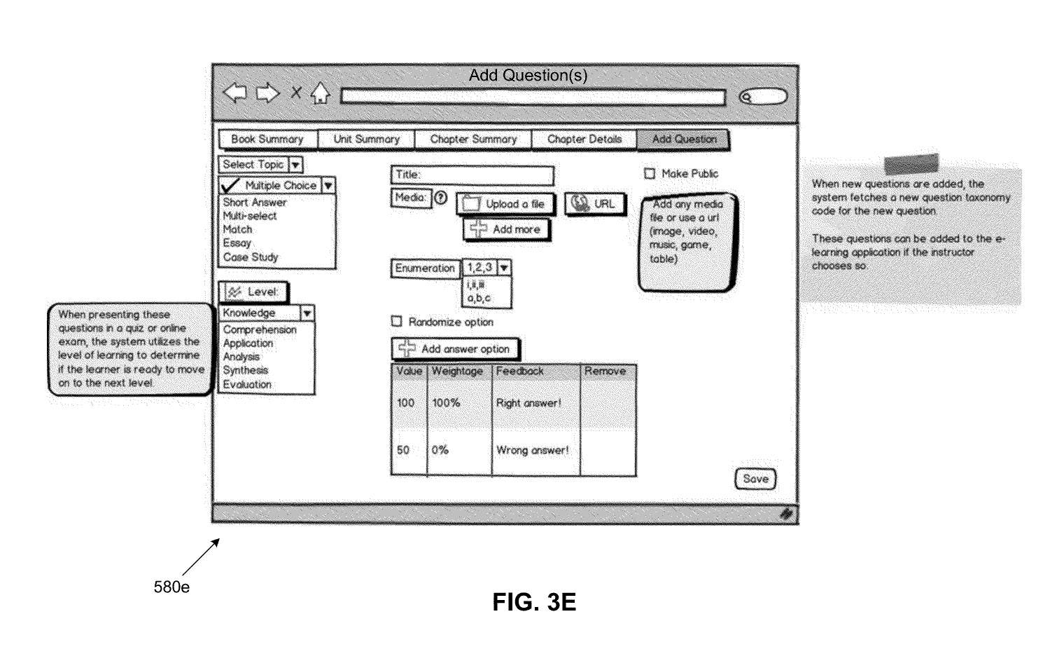

FIGS. 3A-3E are representative author, creator, or contributor GUIs 580a-e that facilitate or enable e-textbook taxonomy and e-textbook content definition, generation, navigation, modification, and/or management in accordance with an embodiment of the present disclosure. Each author GUI 580a-e includes a number of graphical elements or widgets such as menus, text boxes, list boxes, buttons, icons, and the like, in a manner understood by one of ordinary skill in the relevant art.

In an embodiment, a first author GUI 580a corresponds to a book summary. The first author GUI 580a is configured for receiving author input or referencing author information corresponding to a book summary, including a book name or title; an author list; author acknowledgments/quotes; and a definition interface for a number of e-textbook instructional units. A second author GUI 580b corresponds to a unit summary. For each unit defined by way of the first author GUI 580a, the second author GUI 580b is configured for receiving author input or referencing author information corresponding to a unit name, a unit subtitle, a unit summary, and a chapter definition interface for a number of chapters within a unit under consideration. A third author GUI 580c corresponds to a chapter summary. For each chapter defined by way of the second author GUI 580b, the third author GUI 580c is configured for receiving author input or referencing author information corresponding to a chapter name, a chapter subtitle, and a number of chapter points and associated subpoints. A fourth author GUI 580d corresponds to chapter details. For information defined by way of the third author GUI 580c, the fourth author GUI 580d is configured for receiving author input or referencing author information corresponding to a chapter name, a chapter subtitle, introductory chapter text, chapter headings, corresponding paragraphs, and collateral materials such as video, images, charts, tables, questions, activities, case studies, or games that can be selectively added or inserted at one or more locations or positions relative to a given paragraph. A fifth author GUI 580e corresponds to author questions, such as in the context of a quiz or online exam. By way of author interaction with the fifth author GUI 580e, an author can define a number of questions to be added. For any given question, an author can selectively specify a question topic, a question type (e.g., multiple choice, short answer, match, essay, or case study based question), a difficulty or knowledge level associated with the question, collateral materials or media associated or presentable with the question, and an answer weighting function.

In addition to the foregoing, in some embodiments an author GUI 580 or an edition/publication approval GUI (not shown) can facilitate or enable (a) final e-textbook organization and content review by a set of author(s) and/or editor(s) prior to e-textbook publication (e.g., electronic publication); and (b) designation of a current e-textbook edition under consideration as approved by the author(s)/editor(s) and ready for (i) pre-publication instructor review or (ii) publication, licensing, and instructional use. In certain embodiments, separate portions of an e-textbook can be approved/made available for publication (and correspondingly licensed) at separate times.

Furthermore, in a number of embodiments, one or more author GUIs 580 and/or associated, analogous, or counterpart GUIs can be accessible or provided to instructors and/or students (e.g., by way of instructor study course devices 600 or student study course devices 650) to facilitate the provision of instructor and/or student feedback to e-textbook authors based upon instructor or student e-textbook usage, as further detailed below. Such feedback can include instructor and/or student proposed e-textbook organizational and/or content revisions.

The instructional material management engine 200 is configured for automatically or semi-automatically generating instructional materials from content associated with (e.g., contained in and/or referenced by) one or more e-textbooks. The instructional material management engine 200 can generate instructional materials such as portions of an e-learning application, presentation slides, quizzes, and case studies in an appropriate order based upon (a) an e-textbook's taxonomy; and/or (b) author or instructor specified designations, selections, or criteria. Such instructional materials can be communicated or transferred to study course devices 600, 650 corresponding to instructors and/or students to facilitate student learning.

In some embodiments, the instructional material management engine 200 can produce or extract a default set of instructional materials corresponding to a given e-textbook using the e-textbook's taxonomy. A default set of instructional materials can be, for instance, based upon the entire taxonomy. In certain embodiments, the instructional material management engine 200, possibly in association with an instructor's study course device 600, communicates with or provides an instructional material generation GUI (not shown) that is accessible or provided to instructors, such that an instructor can identify (a) one or more e-textbooks, and (b) one or more portions of such e-textbooks from which instructional materials are to be automatically generated. An instructional material generation GUI can facilitate or enable instructor selection of particular taxonomical portions of a given e-textbook under consideration, and instructor designation of particular categorical types of instructional materials to be generated (e.g., in association with instructor specified preferences). In response to instructor selection of a graphical object or element, such as a “create instructional materials” button, the instructional material management engine 200 can generate and store the appropriate instructional materials in accordance with the instructor's selections/preferences. The instructional material generation GUI can also present the generated instructional materials for final instructor review, prior to designating the instructional materials as ready for distribution/use.

Certain embodiments in accordance with the present disclosure include a coursework management engine 300, which is configured for facilitating or enabling instructor definition, generation, or modification of an instructional course; the distribution or retrieval of instructional materials corresponding to the instructional course; and possibly the student submission of corresponding assignments or quizzes to an instructor. A coursework management engine 300 and/or an instructor study course device 600 can provide a set of GUIs by which an instructor can define and/or manage a number of instructional courses and/or associated instructional content. By way of such GUIs, an instructor can define or modify a lesson plan schedule, possibly indicate a list of students to whom instructional materials are to be made available at times in accordance with the lesson plan schedule, and/or define, perform, or schedule additional information, processes, tasks, or activities that are relevant to the provision of course instruction. Such GUIs can additionally or alternatively provide one or more students with direct access to instructional materials, for instance, to facilitate self-paced student learning or study; and generate, provide, or issue one or more instructor notifications or messages indicating to which students particular instructional materials were provided or made available on which dates.

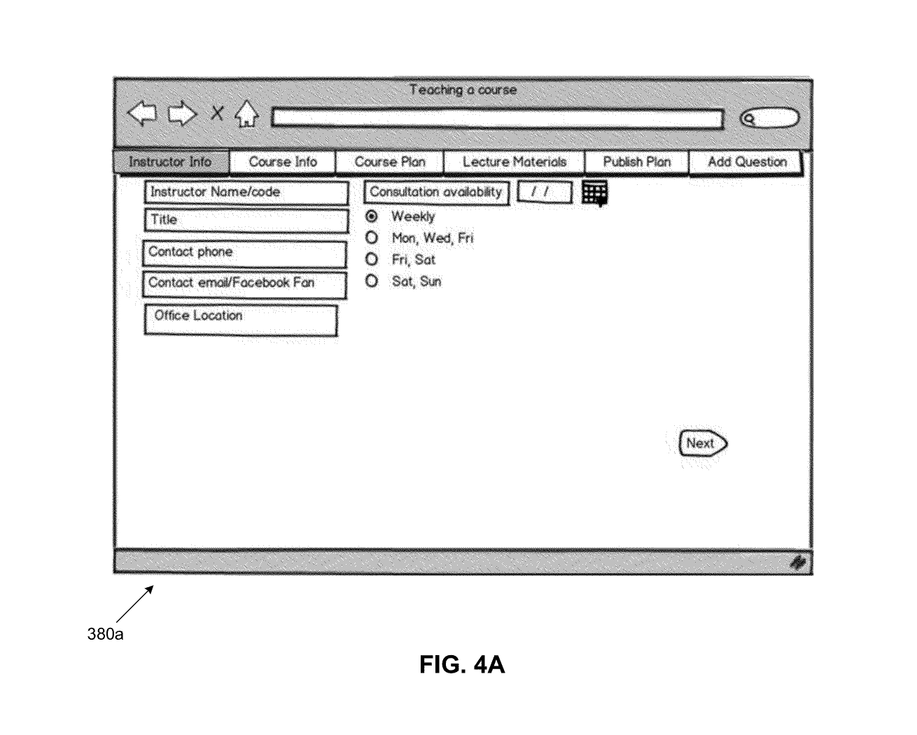

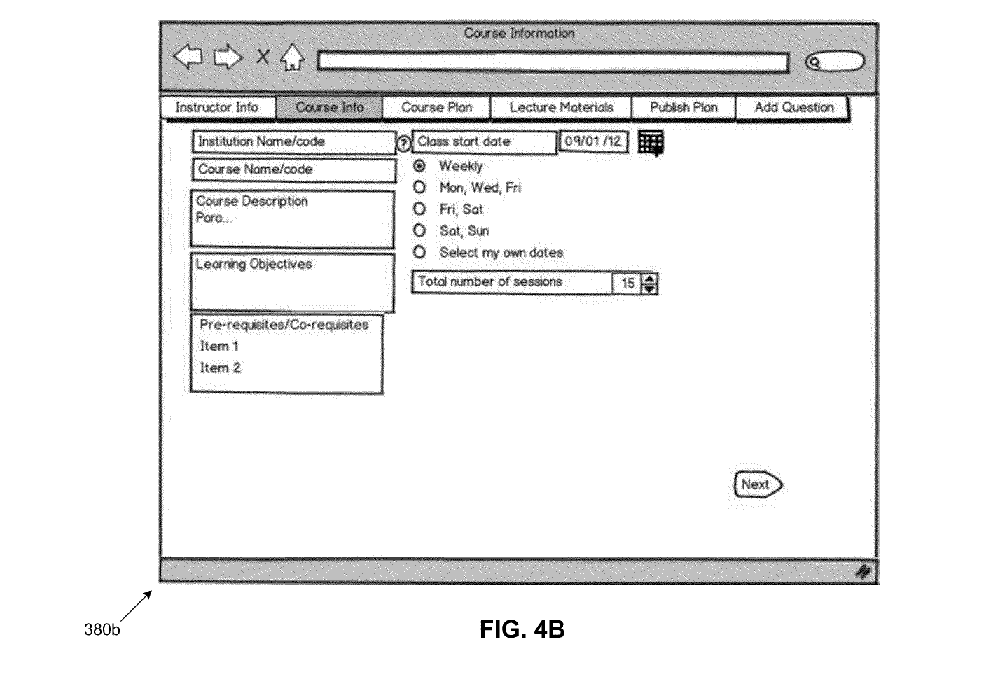

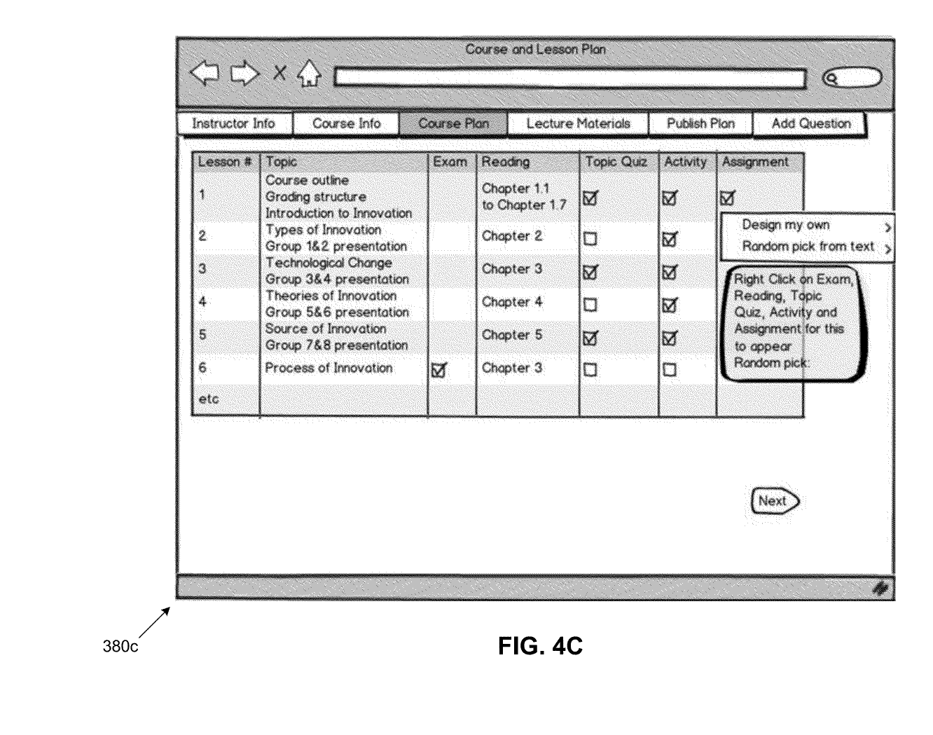

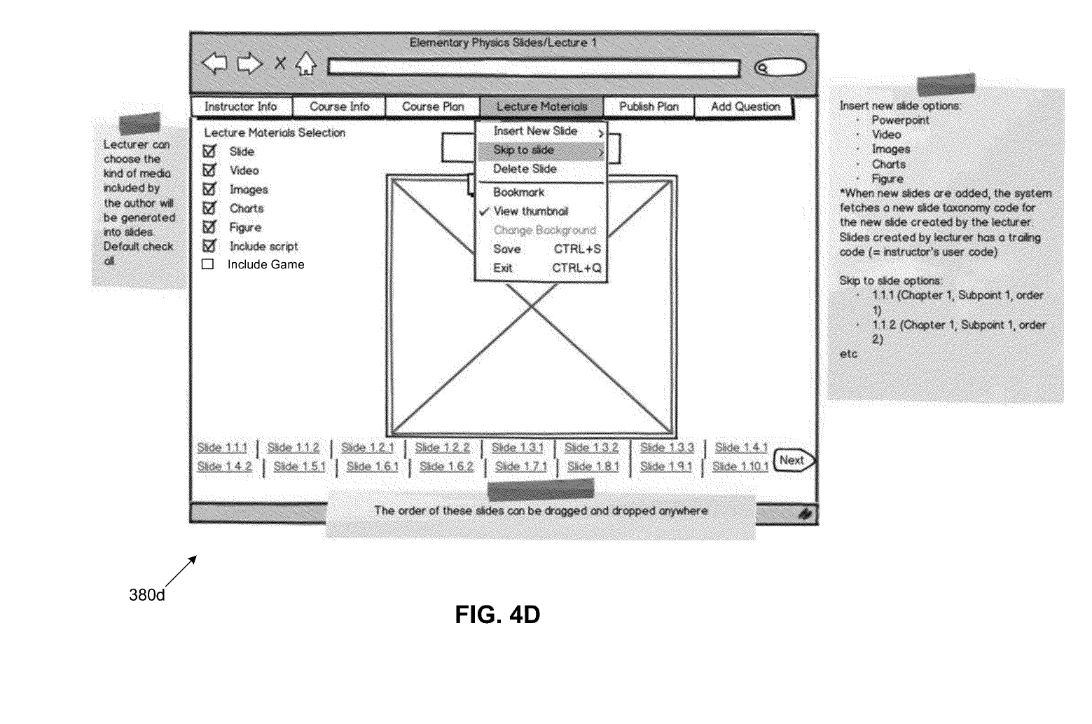

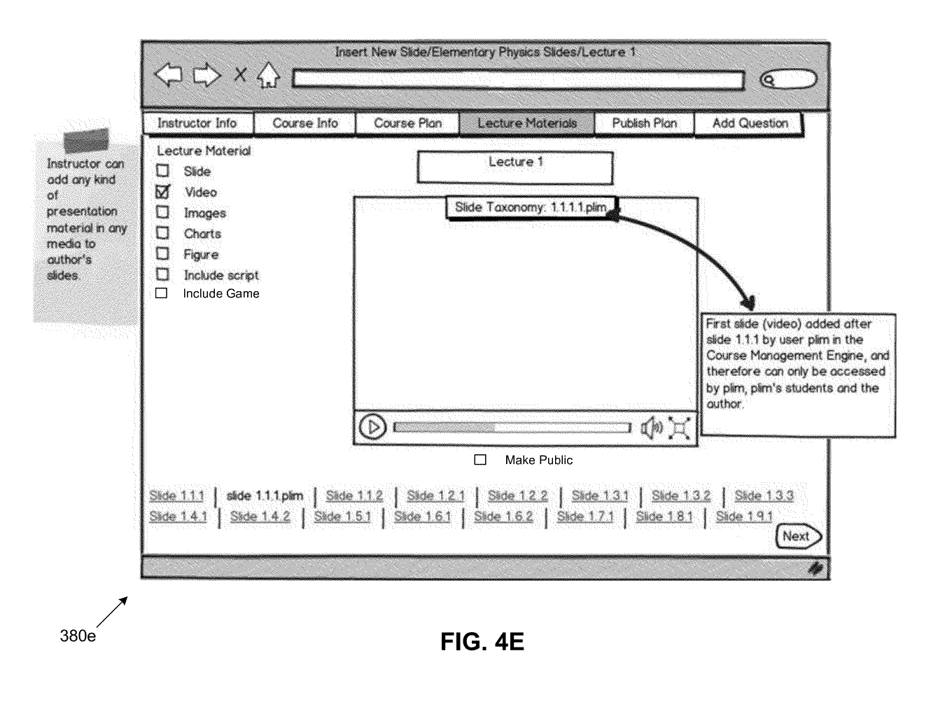

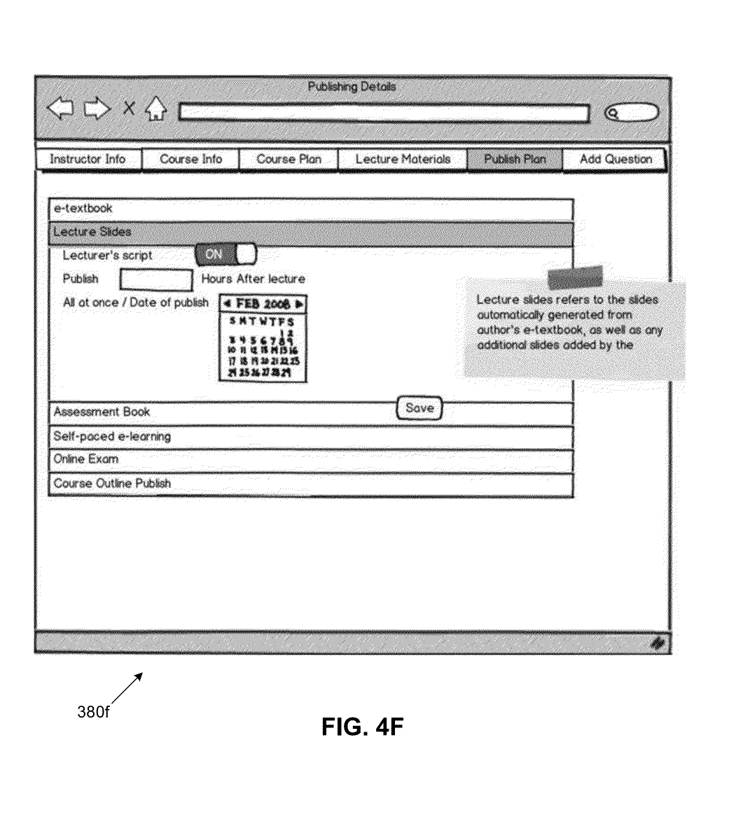

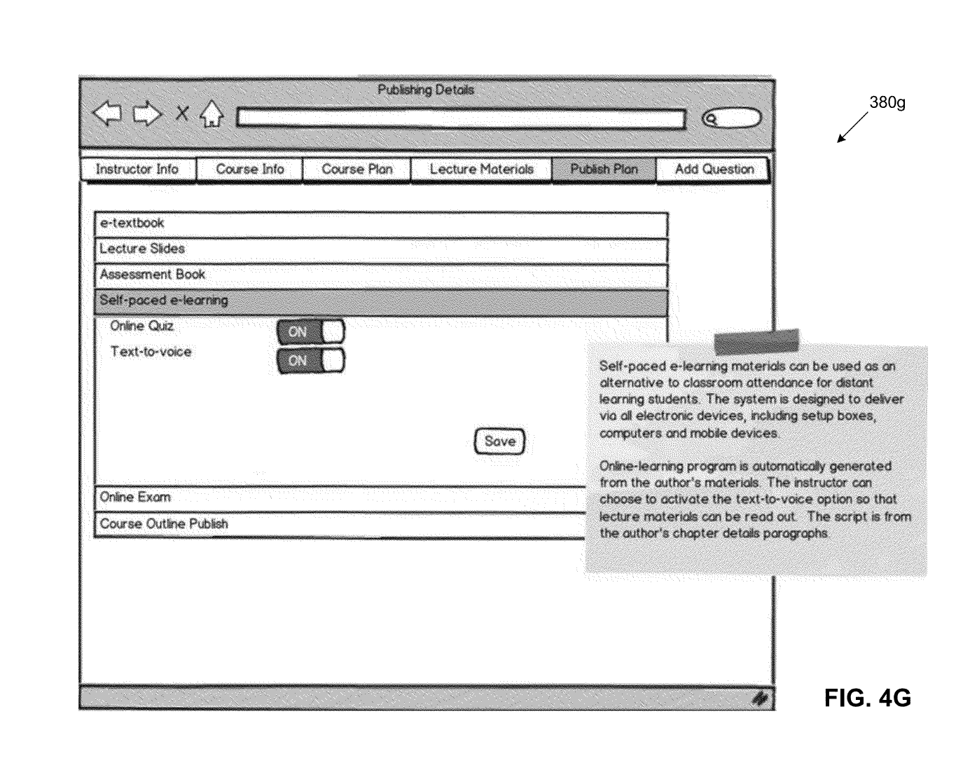

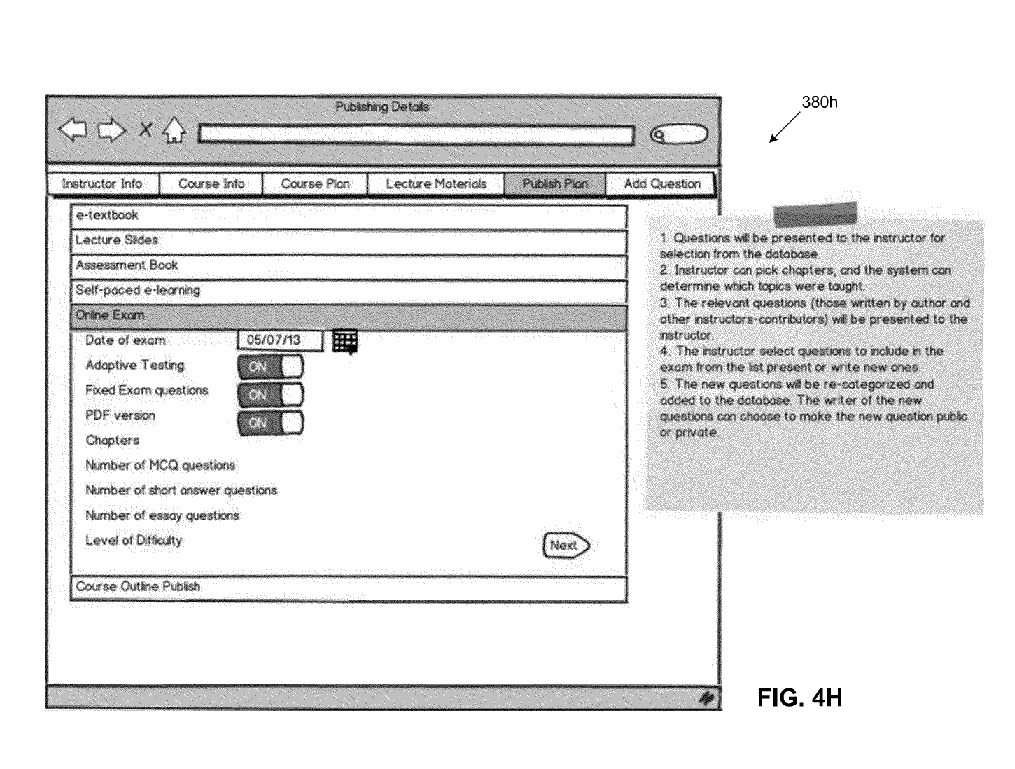

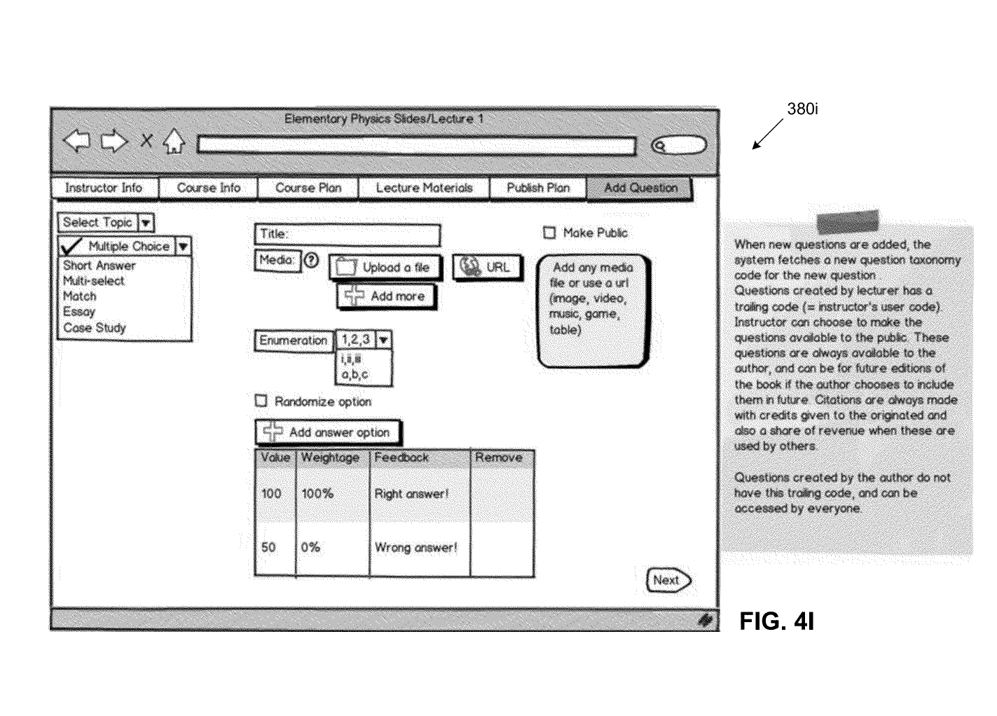

FIGS. 4A-4I are schematic illustrations showing representative coursework management GUIs 380a-i in accordance with an embodiment of the present disclosure. Each coursework management GUI 380 includes a number of graphical objects or widgets, such as menus, text boxes, list boxes, buttons, icons, and the like, in a manner understood by one of ordinary skill in the relevant art. In an embodiment, a first coursework management GUI 380a is configured for receiving input defining or identifying general course information, such as an institution name/code; a course name/code; a course description; learning objectives; prerequisites; and a class schedule or calendar. A second coursework management GUI 380b is configured for receiving input defining or identifying an instructor name/code; an instructor title; instructor contact information (e.g., telephone number(s), e-mail address(es), social media ID(s)), and a consultation schedule or calendar. A third coursework management GUI 380c is configured for receiving input defining or identifying a course and/or lesson plan, which can specify a set of lessons, topics included in each lesson, and associated reading, quiz, activity, assignment, and exam materials.

A fourth coursework management GUI 380d is configured for facilitating instructor definition of lecture materials, such as by way of receiving input corresponding to the insertion of lecture material items or objects that can include slides, vide, images, charts, figures, scripts, or games. In some embodiments, an instructor can (re)organize or (re)order lecture materials that they have defined or identified by way of drag and drop operations. Any given lecture material item, such as a slide, can automatically be (re)assigned a taxonomic code based upon such instructor (re)organization or (re)ordering.

A fifth coursework management GUI 380e illustrates a representative manner in which a an instructor provided or generated slide can be automatically or adaptively inserted or included at a particular location within a set of author defined slides, and generate an appropriate corresponding taxonomic code for the instructor generated slide(s) relative to the taxonomic codes associated with the author defined slides. The fifth coursework GUI 380e can include a selectable GUI element by which an instructor can designate their instructor provided/generated slide(s) as publicly viewable/accessible/distributable, or viewable/accessible/distributable without restriction. By default, a set of instructor provided/generated slides may be designated as private, and may be viewable/accessible only to the instructor (e.g., specifically for instructor presentation during a lecture).

A sixth coursework management GUI 380f corresponds to a publishing or distribution interface by which an instructor can designate a publication or distribution schedule for lecture materials such as lecture slides. By way of a seventh coursework management GUI 380g, an instructor can define a publication or distribution plan or schedule for a self-paced e-learning program or course. An e-learning program or course can involve the distribution of instructional materials to essentially any or all types of electronic devices, such as a mobile telephone, a tablet or note-type computer, a laptop or desktop computer, a set top box, or another type of device. The seventh coursework management GUI 380g can include selectable controls that control aspects of instructional material publication, such as the inclusion of text-to-speech presentation of particular instructional materials. An eighth coursework management GUI 380g is configured for receiving instructor input defining online exam parameters, including an exam date, an adaptive testing option, a fixed question option, a .pdf or hard/paper copy option, chapter associations, exam question types and numbers, and level of difficulty.

A ninth coursework management GUI 380i is configured for receiving instructor input corresponding to instructor provided or instructor generated questions. The ninth coursework management GUI 380i can be identical, substantially identical, or similar to the fifth author GUI 580e described above. Questions created by an instructor can be automatically associated with an appropriate type of taxonomic code to indicate the questions are of instructor origin, rather than author origin.

In particular embodiments, a coursework management GUI 380 can additionally, for instance, in association or conjunction with a student study course device 650, facilitate or enable the receipt, retrieval, or submission of answered student quizzes. In specific embodiments, the coursework management GUI 380 facilitates or enables instructor identification or definition of reference quiz answers, such that the coursework management engine 300 can automatically or semi-automatically score answered student quizzes based upon such reference quiz answers.

As indicated above, in the context of various embodiments in accordance with the present disclosure e-textbook related feedback can include e-textbook content reviews; instructor and/or student proposed content revisions or additions; and e-textbook content usage data/statistics. Similarly, instructional material content feedback can include instructional material reviews; student proposed instructional material content revisions or additions; and usage data/statistics corresponding to student usage of instructional materials. Such types of feedback facilitates collaborative or social interaction between e-textbook authors and instructional class participants, and the generation of subsequent e-textbook editions and/or instructional materials in a manner that adaptively evolves over time based upon how one or more portions of an e-textbook or instructional materials associated therewith are actually used.

In various embodiments, the feedback management engine 400 facilitates or enables the provision or management of (a) student feedback relating to e-textbook and/or instructional material content to instructors, as well as (b) instructor and/or student feedback relating to e-textbook content to e-textbook authors, creators, contributors, and/or editors. The acquisition, generation, receipt, or management of such types of feedback involve communication between the feedback management engine 400, instructor study course devices 600, and student study course devices 650, aspects of which are further detailed hereafter.

In an embodiment, the set of study course devices 600, 650 includes (a) at least one instructor study course presentation and management device 600 configured for aiding and monitoring an instructor's management of a number of instructional classes or courses of study; and (b) a set of student study course presentation and management devices 650 configured for enabling and monitoring student usage of or interaction with e-textbook content and instructional materials. Each of an instructor study course device 600 and a student study course device 650 includes a computer system or computing device such as a desktop, laptop, or tablet computer having processing, memory, operating system, data storage, and communication resources. An instructor study course device 600 and/or a student study course device 650 can additionally or alternatively include a related or other type of electronic device, for instance, a mobile telephone.

An instructor study course device 600 includes a number of program instruction sets (e.g., software) configured for managing aspects of an instructor's presentation and usage of instructional materials, e-textbook content, and possibly other course related information. Similarly, a student study course device 650 includes program instruction sets configured for managing aspects of student access to and usage of instructional materials, e-textbook content, and possibly other instructional course related information.

Furthermore, an instructor study course device 600 includes program instruction sets, such as instructor-side course monitoring/analysis software, configured for monitoring/analyzing instructor use or presentation of instructional materials and e-textbook content to students. Similarly, a student study course device 650 includes program instruction sets, such as student-side course monitoring/analysis software, configured for monitoring/analyzing student access to and use of instructional materials and e-textbook content.

In certain embodiments, instructor-side course monitoring/analysis software can be a built-in or packaged-in portion of an instructor study course device 600. Similarly, student-side course monitoring/analysis software can be a built-in or packaged-in portion of a student study course device 650. Alternatively, instructor-side course monitoring/analysis software or student-side course monitoring/analysis software can be downloadable or retrievable software, for instance, which can be installed or executed in association with access, provision, or retrieval of instructional material or e-textbook content by an instructor study course device 600 or a student study course device 650, respectively.

Instructor-side and student-side course monitoring/analysis software can perform one or more types of course monitoring/analysis operations, procedures, or processes (e.g., on a predetermined, selectable, or programmable basis). For instance, in a representative embodiment, instructor-side course monitoring/analysis software can determine or track whether, when, and/or how often an instructor accesses or presents particular instructional material and/or e-textbook content to students, as well as how much time is spent presenting such content. Student-side course monitoring/analysis software can determine or track what instructional material and/or e-textbook content a student accesses, highlights, or annotates; an amount of time such content is displayed or presented; whether such content is accessed during study group sessions involving information sharing or communication between multiple student study course devices 650; whether such content is referred to during completion or attempted completion of student quizzes. An instructor or student study course device 600, 650 can communicate data and/or statistics associated with one or more of the foregoing course monitoring/analysis operations, procedures, or processes, along with an e-textbook, e-textbook content, and/or instructional course identifier, to a feedback management engine 400.

Based upon feedback received from one or more instructor and/or student study course devices 600, 650, a feedback management engine 400 can provide information or statistics to an e-textbook author, creator, contributor, or editor, such as statistical information identifying which chapters, subchapters, paragraphs, figures, and/or case studies within an e-textbook were most commonly or repeatedly accessed or studied. Such information can convey how e-textbook and/or instructional material content was actually used by instructors and/or students, which can facilitate the generation of updated editions of an e-textbook or instructional material associated therewith.

Aspects of particular embodiments of the present disclosure address at least one aspect, problem, limitation, and/or disadvantage associated with exiting e-textbook creation, management, or usage systems and methods. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed systems, components, processes, or alternatives thereof, may be desirably combined into other different systems, components, processes, and/or applications. In addition, various modifications, alterations, and/or improvements may be made to various embodiments that are disclosed by a person of ordinary skill in the art within the scope and spirit of the present disclosure.

1. An automated method for managing electronic textbook (e-textbook) content generation, distribution, and usage by way of a computer network, the method comprising:
receiving inputs corresponding to first e-textbook content from at least one e-textbook author by way of an author interface in communication with a content authoring engine;
automatically associating the first e-textbook content with an e-textbook taxonomy;
automatically generating a first e-textbook corresponding to the first e-textbook content in accordance with the e-textbook taxonomy; and
automatically generating instructional materials corresponding to portions of the first e-textbook in accordance with an instructional materials taxonomy.

2. The method of claim 1, wherein the e-textbook taxonomy comprises hierarchical classifications corresponding to an e-textbook summary, a unit summary, a chapter summary, chapter details, and author questions.

3. The method of claim 1, wherein the instructional materials taxonomy is one of a default instructional materials taxonomy and an instructor specified instructional materials taxonomy corresponding to instructor inputs received by way of an instructional material management engine.

4. The method of claim 1, wherein the instructional materials taxonomy comprises hierarchical classifications corresponding to instructor information, course information, a course plan, lecture materials, a publishing plan, and instructor questions.

5. The method of claim 1, further comprising communicating at least one of first e-textbook content and instructional materials to at least one e-learning application.

6. The method of claim 5, where communicating at least one of first e-textbook content and instructional materials to at least one e-learning application comprises selectively communicating at least one of first e-textbook content and instructional materials corresponding thereto to a set of student study course devices in accordance with a publishing plan that forms a portion of the instructional materials taxonomy.

6. The method of claim 5, further comprising:
receiving feedback corresponding to at least one of the first e-textbook and the instructional materials corresponding thereto by way of a feedback engine; and
providing feedback to at least one of at least one author of the first e-textbook and at least one instructor,
wherein the feedback corresponds to at least one of (a) how instructional materials are utilized by at least one instructor, (b) how instructional materials or first e-textbook content are utilized by students, and (c) a recommendation for revising first e-textbook content in a subsequent edition of the first e-textbook.

7. The method of claim 5, further comprising
automatically monitoring at least one of instructor usage of first e-textbook content, student usage of first e-textbook content, and student usage of instructional materials; and
automatically generating statistics corresponding to the automatically monitored at least one of instructor usage of first e-textbook content, student usage of first e-textbook content, and student usage of instructional materials.

8. The method of claim 1, further comprising:
receiving inputs corresponding to second e-textbook content from at least one e-textbook author by way of the author interface;
automatically associating the second e-textbook content with the e-textbook taxonomy;
automatically generating a second e-textbook corresponding to the second e-textbook content in accordance with the e-textbook taxonomy; and
automatically generating instructional materials corresponding to portions of the first e-textbook and portions of the second e-textbook in accordance with the instructional materials taxonomy.

9. An automated method for managing electronic textbook (e-textbook) content generation, distribution, and usage by way of a computer network, the method comprising:
receiving inputs corresponding to first e-textbook content from at least one e-textbook author by way of an author interface in communication with a content authoring engine;
automatically associating the first e-textbook content with an e-textbook taxonomy;
automatically generating a first e-textbook corresponding to the first e-textbook content in accordance with the e-textbook taxonomy;
communicating portions of the first e-textbook to at least one of an instructor study course device and a student study course device;
automatically monitoring at least one of (a) instructor access to or usage of first e-textbook content, (b) student access to or usage of first e-textbook content, and (c) student access to or usage of instructional materials corresponding to first e-textbook content; and
automatically generating statistics corresponding to the automatically monitored at least one of (a) instructor access to or usage of first e-textbook content, (b) student access to or usage of first e-textbook content, and (c) student access to or usage of the instructional materials corresponding to first e-textbook content.

10. An automated system for managing electronic textbook (e-textbook) content generation, distribution, and usage by way of a computer network, the system comprising an e-textbook management system having a processing unit, a memory coupled to the processing unit, and a set of engines stored in the memory and executable by the processing unit, the set of engines comprising:
a content authoring engine communicable with the computer network and configured for receiving inputs from least one author interface system to control contents of a first e-textbook and configured for automatically generating the first e-textbook in accordance with an e-textbook taxonomy; and
an instructional materials management engine communicable with the computer network and configured receiving instructor inputs from an instructor study course device, the instructor inputs selectively identifying instructional materials content corresponding to portions of the first e-textbook, the instructional materials management engine further configured for automatically generating instructional materials in accordance with an instructional materials taxonomy.

11. The system of claim 10, wherein e-textbook management system further comprises a coursework management engine communicable with the computer network and configured for communicating at least one of first e-textbook content and instructional materials corresponding thereto to at least one student study course device.

12. The system of claim 11, wherein the instructor study course device comprises one of a desktop computing device, a laptop computing device, a tablet computing device, and a mobile telephone, and wherein the student study course device comprises one of a desktop computing device, a laptop computing device, a tablet computing device, a mobile telephone, and a set top box.

13. The system of claim 11, wherein the coursework management engine is configured for communicating at least one of first e-textbook content and instructional materials corresponding thereto in accordance with a publishing schedule that forms a portion of the instructional materials taxonomy.

14. The system of claim 11, wherein the wherein e-textbook management system further comprises a feedback management engine communicable with the computer network and configured for receiving feedback from at least one of an instructor study course device and at least one student study course device, wherein the feedback corresponds to at least one of (a) how instructional materials are utilized by an instructor corresponding to the instructor study course device, (b) how instructional materials or first e-textbook content are utilized by a student corresponding to a student study course device, and (c) an instructor or a student recommendation for revising first e-textbook content in a subsequent edition of the first e-textbook.

15. The system of claim 14, wherein the instructor study course device includes a processing unit, a memory, and instructor-side course monitoring/analysis program instructions that reside within the memory and which are executable by the processing unit, the instructor-side course monitoring/analysis program instructions configured for monitoring or analyzing instructor use or presentation of first e-textbook content or instructional materials corresponding thereto.

16. The system of claim 15, wherein the instructor-side course monitoring/analysis program instructions are configured for tracking at least one of whether, when, and how often an instructor study course device accesses particular first e-textbook content or instructional material corresponding thereto, and how much time is spent presenting first e-textbook content or instructional material thereto.

17. The system of claim 15, wherein the instructor-side course monitoring/analysis program instructions comprise one of (a) a built-in or packaged-in portion of the instructor study course device, and (b) downloadable or retrievable software.

18. The system of claim 14, wherein the student study course device includes a processing unit, a memory, and student-side course monitoring/analysis program instructions that reside within the memory and which are executable by the processing unit, the student-side course monitoring/analysis program instructions configured for monitoring or analyzing student access to and use of first e-textbook content and instructional materials corresponding thereto.

19. The system of claim 18, wherein the student-side course monitoring/analysis program instructions are configured for tracking at least one of (a) what first e-textbook content or instructional material corresponding thereto a student accesses, highlights, or annotates, (b) an amount of time student accessed first e-textbook content or instructional material corresponding thereto is displayed, (c) whether student accessed first e-textbook content or instructional material corresponding thereto is accessed during a study group session involving information sharing between multiple student study course devices, and (d) whether first e-textbook content or instructional material corresponding thereto is accessed during a student quiz.

20. The system of claim 18, wherein the student-side course monitoring/analysis program instructions comprise one of (a) a built-in or packaged-in portion of the student study course device, and (b) downloadable or retrievable software.

21. The system of claim 10, wherein the content authoring engine is configured for receiving inputs from a plurality of author interface systems to control contents of a plurality of distinct e-textbooks, and configured for generating a plurality of distinct e-textbooks in accordance with the e-textbook taxonomy, and wherein the instructional materials management is configured receiving instructor inputs from a plurality of instructor study course devices, the instructor inputs received from any given instructor study course device selectively identifying instructional materials corresponding to portions of at least one e-textbook, the instructional materials management engine further configured for automatically generating instructional materials corresponding to the at least one e-textbook in accordance with the instructional materials taxonomy.

22. An automated system for managing electronic textbook (e-textbook) content generation, distribution, and usage by way of a computer network, the system comprising:
an e-textbook management system communicable with the computer network, the e-textbook management system having a processing unit, a memory coupled to the processing unit, and a set of engines stored in the memory and executable by the processing unit, the set of engines comprising a content authoring engine communicable with the computer network and configured for receiving inputs from least one author interface system to manage contents of a first e-textbook and configured for automatically generating the first e-textbook in accordance with an e-textbook taxonomy; and
at least one of:
an instructor study course device communicable with the computer network, the instructor study course device comprising a processing unit, a memory, and instructor-side course monitoring/analysis program instructions that reside within the instructor study course device memory and which are executable by the instructor study course device processing unit, the instructor-side course monitoring/analysis program instructions configured for monitoring or analyzing instructor use or presentation of first e-textbook content or instructional materials corresponding thereto; and
a set of student study course devices communicable with the computer network, each student study course device comprising a processing unit, a memory, and student-side course monitoring/analysis program instructions that reside within the student study course device memory and which are executable by the student study course device processing unit, the student-side course monitoring/analysis program instructions configured for monitoring or analyzing student access to and use of first e-textbook content or instructional materials corresponding thereto.

23. The system of claim 22, wherein the set of engines further comprises a feedback management engine configured for communicating with at least one of the instructor study course device and the set of student study course devices to receive feedback corresponding to at least one of (a) instructor use or presentation of first e-textbook content or instructional materials corresponding thereto, and (b) student access to or use of first e-textbook content or instructional materials corresponding thereto.
